(19) United States
(12) Patent Application Publication
(10) Pub. No.: US 2026/0098105 A1
(43) Pub. Date: Apr. 9, 2026

(54) PREPOLYMERIZED CATALYST FOR OLEFIN POLYMERIZATION, METHOD OF PRODUCING THIS PREPOLYMERIZED CATALYST AND METHOD OF PRODUCING OLEFIN POLYMER WITH IMPROVED PROCESSABILITY AND OPTICAL PROPERTIES

(71) Applicant: Formosa Plastics Corporation, U.S.A., Livingston, NJ (US)

(72) Inventors: Guangxue XU, Port Lavaca, TX (US); Zhiming WANG, Port Lavaca, TX (US); Cyrus C.Y. LEE, Victoria, TX (US); Chih-Jian CHEN, Port Lavaca, TX (US)

(73) Assignee: Formosa Plastics Corporation, U.S.A., Livingston, NJ (US)

(21) Appl. No.: 18/909,520

(22) Filed: Oct. 8, 2024

(51) Int. Cl. C08F 4/10; C08F 2/34

(52) U.S. Cl. CPC C08F 4/10; C08F 2/34

(57) ABSTRACT

The present invention relates to a prepolymerized catalyst made by the prepolymerization of olefin with a catalyst precursor and an activator in-situ. The prepolymerized catalyst of the present invention has better morphology, less fine particle size, and less static/better powder flow ability, which is capable of preventing fouling of olefin polymer particles to a polymerization reactor. In some embodiments, the prepolymerized catalyst produces polyethylene (co) polymers containing sporadic long chain branches in high molecular weight fractions, comprising a high molecular weight tail along with reversed comonomer composition distribution and showing improved processability, enhanced melt strength and improved optical properties.

### BACKGROUND

The present invention relates to a prepolymerized catalyst for olefin (co) polymerization, a method of producing the prepolymerized catalyst and a method of producing polyethylene using the same. The present invention also relates to the process for making said prepolymerized catalyst and said polyethylene copolymers with improved processability, enhanced melt strength and better optical properties.

Various types of polyethylene are known in the art. Low density polyethylene (LDPE) is generally prepared at high pressure using free radical initiators and typically has a density in the range of 0.9100-0.9400 g/cc. High density polyethylene (HDPE) usually has a density in the range of 0.9400-0.9600 g/cc, which is prepared with Ziegler-Natta type catalysts or single-site type catalysts (such as metallocene catalysts) at low or moderate pressures. HDPE is generally polymerized without comonomer, or alternatively with a small amount of comonomers with fewer short chain branches (SCB) than LLDPE. Linear low density polyethylene (LLDPE) is one of the ethylene/alpha-olefins copolymers, generally prepared in the same manner as HDPE, except it incorporates a relatively higher amount of alpha-olefin comonomers such as 1-butene, 1-hexene or 1-octene.

Conventionally, it is known to produce an olefin polymer in the form of particles using a particulate solid catalyst in olefin gas phase polymerization or slurry polymerization in which an olefin is polymerized in a gas phase or slurry state to produce an olefin polymer. A particulate solid catalyst applied to gas phase polymerization or slurry polymerization is required to provide an olefin polymer excellent in particle property and state, and for example, prior arts describes a uniform solid catalyst component or uniform solid catalyst from which fine powder removed, and it is described that an olefin may be prepolymerized to the above-described uniform solid catalyst component or uniform solid catalyst to give prepolymerized catalyst. Examples of such prepolymerized catalysts are described in U.S. Pat. Nos. 8,293,857; 4,748,221, and European Patent Nos: EP0453088B1; EP0529977B1; EP0703246B1, which are incorporated by reference herein in their entireties. However, also in olefin gas phase or slurry polymerization using the prepolymerized catalyst as described above, it is required to prevent fouling of olefin polymer particles to interior portions of a polymerization reactor, for example, to enlarged parts of a polymerization reactor, and a prepolymerized catalyst for olefin polymerization which is capable of preventing fouling of olefin polymer particles to a polymerization reactor has been required.

These prepolymerized catalysts in prior arts mentioned above were prepared by Ti-based component, alkyl aluminum, and ethylene in the presence of hydrogen. It was found that these prepolymerized catalyst show broad particle size distribution as well as poor morphology and poor operability for producing lower density resins, and inferior comonomer incorporation. The LLDPE resins obtained using such prepolymerized catalyst do not have the narrow molecular weight distribution and compositional distribution that are desirable for high performance resins. Moreover, without costly improvement of gas phase process as described U.S. Pat. Nos. 6,291,613 and 7,652,113, the polymerization catalyst composition cannot produce LLDPE with a density of less than 0.917 at economically favorable production rates because of poor powder flowability. The poor flowability is caused by resin stickiness, chunk formation, and reactor fouling.

Assignee's prior patents, such as U.S. Pat. Nos. 7,618,913; 8,993,693; and 9,487,608, describe a highly active supported Ziegler-Natta catalyst system with a nitrogen-based electron donor for producing unique ethylene copolymer. Both catalyst component and a prepolymerized catalyst component, activating with trialkylaluminum compound, produce ethylene-based polymer or co-polymer having narrower molecular weight distribution, more uniform comonomer composition distribution, and better mechanical properties, such as dart impact and tear strengths. The blown films from said LLDPE polymer show a MD tear strength that is higher than super-hexene ZN LLDPE and dart impact strength on par with mLLDPE. Fractionation analysis of the LLDPE polymer showed that high molecular weight fractions with M_{w}>30,000 g/mol have flat comonomer composition distribution. The intrinsic viscosity of these fractions conforms to the Mark-Houwink equation, indicating that only linear structure exists in these high MW fractions. The linear and very high molecular weight (>30,000 g/mol) polymer chains tend to form thicker crystallization lamella and causes rough surface for blown films. Accordingly, the films made with the said LLDPE polymer show inferior optical properties with a haze of >21%, compared to optical properties with a haze of lower than 12% for the typical m-LLDPE films or ethylene/1-octene copolymer (C8-LLDPE) made with solution process. The high haze limits their applications for clarity films. In addition, the linear structure along with very high molecular weight and narrow molecular weight distribution also leads to undesirable rheological behavior and processability. For example, the melt strength of said polymer is not sufficient for applications requiring certain extensional flow properties during processing, such as blow molding and geomembrane production.

Assignee's prior patents, such as U.S. Pat. Nos. 10,344,105, and 11,952,445, describe the process for making polyethylene copolymers and its composition by using a mixed cocatalyst from TEAL/EADC or TnOA/DMAC or MAO/EADC. However, reactor fouling or poor operability in gas phase reactor was observed, which result in lower production rate and reactor shutdown frequently.

Therefore, there is a need to develop a new prepolymerized catalyst and a compatible process through which catalyst morphology and flowability is improved, operation efficiency of producing LLDPE polymers with lower density is enhanced without issues of chunk formation and reactor fouling, high catalyst activity and catalyst productivity is enhanced, and the microstructure of the LLDPE polymers, such as molecular weight distribution, comonomer composition distribution, and the long chain branching content in high molecular weight fractions, is tuned to the desirable level for tailoring polymer properties. LLDPE polymers with the desirable microstructure provide the corresponding blown films with improved processability and enhanced melt strength, and improved optical properties without significantly sacrificing other physical properties, such as tear and dart impact strengths.

### SUMMARY OF THE INVENTION

An object of the present invention is to provide a prepolymerized catalyst for olefin polymerization which is capable of preventing fouling of olefin polymer particles to a polymerization reactor when producing polymer with lower density of down to 0.9100, a method of producing the prepolymerized catalyst, and a method of producing an olefin polymer using the same.

The method of producing a prepolymerized catalyst for olefin polymerization according to the present invention comprises a prepolymerization process by polymerizing ethylene with a catalyst precursor, an activator formed by contacting alkylaluminoxane with halogenated alkylaluminum, and electron modifier in the presence of hydrogen. In the method of producing a prepolymerized catalyst according to present invention, the prepolymerized catalysts contain Ti, Mg, Si, halogen, nitrogen, and polyethylene carrier/support having sporadic long chain branches in high molecular weight fractions and a high molecular weight tail.

In accordance with one embodiment, the present invention provides a method for preparing prepolymerized catalyst by (co) polymerizing ethylene and/or alpha olefins in the presence of a unique catalyst precursor and an organohalogenous aluminum compound (called an activator) prepared in-situ by contacting alkylaluminoxane with halogenated alkylaluminum compounds and electron modifier of the R₃Si—NH—SiR₃-type disilazanes. The prepolymerized catalyst has an amount ranging from 0.1 to 1000 g per g of said solid catalyst precursor, being characterized by its sporadic long chain branches in the high molecular weight fractions and an improved comonomer response for the copolymerization of ethylene with alpha-olefin without using additional co-catalyst. The catalyst precursor is prepared by contacting a magnesium-based composite support, in-situ prepared by contacting metallic magnesium with alkyl halide or aromatic halide in the presence of an organic silicon compound having the formula R¹ₘSi(OR²)ₙ, wherein R¹ and R² are C₁-C₂₀ hydrocarbyl, m is an integer between 0 and 3, n is an integer between 1 and 4, and m+n=4, and wherein each R¹ and each R₂ may be the same or different, with a compound having the formula R³ₓSiX_{y}, wherein R³ is a C₁-C₂₀ hydrocarbyl, X is halogen, x is an integer between 0 and 3, y is an integer between 1 and 4, and x+y=4, and wherein each X and each R³ may be the same or different; a compound having the formula MX₄, wherein M is an early transition metal such as Ti; a compound having the formula M(OR⁴)ₐX₄₋ₐ, wherein M is an early transition metal such as Ti, wherein R⁴ is a C₁-C₂₀ hydrocarbyl, X is halogen, and 0≤a≤4; and a substituted aromatic compound containing nitrogen, such as 2,6-dimethylpyridine.

In one embodiment, the prepolymerized catalyst has a particle size distribution span ((d₉₀−d₁₀)/d₅₀) of below about 1.5, more preferably below about 1.2. A small amount of fine particles (<80 micron) produced have the typical fine particle content from about 2 to about 12 wt. %, and preferably from about 5 to about 10 wt. %.

In the method of producing an olefin polymer according to the present invention, polymerization of an olefin and copolymerization of ethylene with alpha-olefins are performed using the novel prepolymerized catalyst for olefin polymerization produced by the above-described production method.

By the production method of the present invention, a prepolymerized catalyst that is capable of preventing fouling of olefin polymer particles to a polymerization reactor is obtained, and if an olefin is polymerized using this prepolymerized catalyst, without adding additional cocatalyst during olefin polymerization, fouling of olefin polymer particles to a polymerization reactor can be prevented when producing polymer with very low density of less than about 0.9130.

In accordance with another embodiment, the present invention provides a method for preparing polyethylene copolymers, especially LLDPE polymers, by polymerizing ethylene and/or alpha-olefin with the prepolymerized catalyst described above, without additional cocatalyst added during olefin polymerization. The polyethylene copolymers produced according to the present invention have sporadic long chain branch structures (defined as JC-α) and a high molecular weight tail along with uniform short chain branching distribution across the molecular weight distribution and reversed comonomer composition distribution in the high molecular weight fractions. As a result, polyethylene copolymers produced according to the present invention demonstrate unique rheology behavior for higher melt strength, and thus improve the extrusion processability and film optical properties (haze % and clarity), while maintaining excellent tear strength and impact properties in the film applications.

### DETAILED DESCRIPTION OF THE INVENTION

In the present invention, prepolymerization means the polymerization of a small amount of olefin on a catalyst component prepared for olefin polymerization, thereby forming an olefin polymer on the catalyst component. The prepolymerized catalyst means a catalyst by prepolymerization of an olefin on a catalyst component for olefin polymerization, and referred to simply as a prepolymerized catalyst in this invention. The content of the prepolymerized polymer in the prepolymerized catalyst for olefin polymerization is preferably 0.01 to 1000 g, more preferably 0.05 to 500 g and further preferably 1.0 g to 200 g, usually per gram of a catalyst precursor. In the present invention, the prepolymerized catalyst particles means particles and/or powder constituting a prepolymerized catalyst and the prepolymerized catalyst has a constitution containing the prepolymerized catalyst particles. The fine particles are prepolymerized catalyst particles having small particle size (fine powder, typically <80 micron) having a possibility of causing problems such as agglomeration of the prepolymerized catalyst, cyclone blockage and the like in the olefin polymerization described above. Small amounts of fine particles (typically <80 micron) produced have the typical fine particle content from about 2 to about 12%, and preferably from about 5 to about 10%. High content of fine particles in the prepolymerized catalyst could bring about issues of high static and hot spots, and should be avoided in the gas phase polymerization.

The particle size of the fine particles can be no larger than D¹ represented by the following formula:

$${D}^{1} = ( average particle size of prepolymerized catalyst particles ) \times 0.35$$

In the prepolymerized catalyst for olefin polymerization according to the present invention, the content of particles having a particle size smaller than D¹ is preferably 10% by weight or less. When the content of particles having a particle size smaller than D¹ described above is high in a prepolymerized catalyst, there is a tendency of occurrence of problems such as agglomeration of the prepolymerized catalyst, cyclone blockage and the like in the olefin polymerization described above. Since the content of such fine particles is 10% by weight or less, the prepolymerized catalyst according to the present invention is capable of preventing generation of the problems in the olefin polymerization described above. The average particle size of a prepolymerized catalyst is determined depending on the size of a catalyst component and the prepolymerization amount of an olefin, and preferably between about 180 μm and about 350 μm. The average particle size of a prepolymerized catalyst can be measured by known particle size distribution measuring methods such as Malvern Laser Diffraction Analyzer.

The particle size and particle size distribution is a measure of the size of the particles. The D-values (D₁₀ or d₁₀, D⁵⁰ or d₅₀, and D₉₀ or d₉₀) represent the intercepts for 10%, 50% and 90% of the cumulative mass of sample. The D-values can be thought of as the diameter of the sphere which divides the sample's mass into a specified percentage when the particles are arranged on an ascending mass basis. For example, the D₁₀ is the diameter at which 10% of the sample's mass is comprised of particles with a diameter less than this value. The D₅₀ is the diameter of the particle where 50% of a sample's mass is smaller than and 50% of a sample's mass is larger than this value. The D₅₀ value is also called the median particle size. The D₉₀ is the diameter at which 90% of the sample's mass is comprised of particles with a diameter less than this value. From laser diffraction measurements according to ISO 13320-1 (or ASTM E3340-22) the volumetric D-values are obtained, based on the volume distribution.

The distribution width or span of the particle size distribution is calculated from the D-values D₁₀, D₅₀, and D₉₀ according to the formula:

$$Span = \frac{D 90 - D 10}{D 50}$$

The prepolymerized solid Ziegler-Natta catalyst has a particle size distribution span ((D₉₀−D₁₀)/d₅₀) of below 2.0, preferably below 1.5. In one embodiment, the prepolymerized catalyst has a particle size distribution span ((D₉₀−D₁₀)/d₅₀) in the range from 1.0 to 2.0, preferably from 1.0 to 1.5, more preferably from 1.0 to 1.2.

The mean particle size corresponds to the average particle size (APS). From laser diffraction measurements according to ISO 13320-1 (or ASTM E3340-22) the volume based mean particle size is obtained and calculated as follows:

$${\overline{D}}_{pq}^{( p - q )} = \frac{\sum {D}_{i}^{p}}{\sum {D}_{i}^{q}}$$

Wherein D̅=the average or mean particle size
(p−q)=the algebraic power of D_{pq}, whereby p>q
Dᵢ=the diameter id i^{th} particle
Σ=the summation of Dᵢₚ or D_{iq} representing all particles in the sample

Only in symmetric particle size distributions the mean particle size (corresponding average particle size, APS) and the median particle size D⁵⁰ have the same value.

In the present invention, the advantage of using the prepolymerized catalyst according to the present invention for gas phase polymerization includes: a) the improvement in the morphology of the catalyst with less fine particle content, which may increase the particle flowability, inhibit the otherwise dramatic initial activity, and facilitate the catalyst to be used for gas phase polymerization in a fluidized bed reactor or stirring bed reactor; b) the ability of tuning the microstructure of the polymer or copolymer produced, such as comonomer composition distribution, molecular weight distribution, high molecular weight fraction (tail) and long chain branching, to the desirable level for tailoring properties of the polymer product.

As the catalyst component for olefin polymerization to be used in the present invention, known polymerization catalyst components used in olefin polymerization can be used, and examples thereof include metallocene, Ziegler-Natta, Phillips type catalysts and the like, preferably Zieger-Natta catalysts. As Ziegler-Natta catalyst, there are mentioned, for example, those formed by contacting co-catalyst, a Ziegler-Natta catalyst precursor and/or an electron donor. The catalyst component for olefin polymerization to be used in the present invention is preferably one formed by contacting a Ziegler-Natta catalyst precursor (hereinafter, described as “component (A)”), an alkylalumoxane (hereinafter, described as “component (B)”), a halogenated alkylaluminum compound (hereinafter, described as “component (C)”), and/or an alkylaluminum compound (hereinafter, described as “component (D)”). The prepolymerized catalyst particles obtained by prepolymerization of an olefin to such a catalyst component for olefin polymerization tend to contain fine particles; the prepolymerized catalyst according to the present invention is particularly suitable for production of an olefin polymer since the content of such fine particles is suppressed.

The process for preparing said prepolymerized catalyst comprises:
i) a magnesium-based supported catalyst precursor (component A) comprising a halide of a transition metal in any of group 4 to 8 of the periodic table of elements and a nitrogen-based electron donor;
ii) an activator produced in-situ by contacting alkylaluminoxane (component B) with halogenated alkylaluminum compound (component C) and R₃Si—NH—SiR₃-type disilazanes (component D);
iii) ethylene;
iv) optionally one or more alpha-olefins;
v) hydrogen

Examples of the Ziegler-Natta catalyst precursor (component A) to be used in the present invention include solid catalyst component formed by contacting the solid magnesium powder, the following component (b1) formed by contacting halogen-substituted silane represented by R¹ₓSiX_{y} with alkoxysilane ester represented by R²ₘSi(OR³)ₙ, the following component (b2) represented by Ti(OR⁴)₄X₄₋ₐ, the following component (b3), and the following component (b4) in the presence of hydrocarbon solvent.

The process to produce said olefin polymer comprises reacting at least the following components with each other:
i) said prepolymerized catalyst as described above, without adding additional cocatalyst
ii) ethylene;
iii) optionally one or more alpha-olefins; and
iv) hydrogen

In accordance with one embodiment, Ziegler-Natta catalyst precursor (component A) is prepared by:
(i) contacting spherical magnesium particles with iodine hexane solution in the presence of RX, wherein R is C1-C20 hydrocarbyl or aryl, and X is halogen;
(ii) contacting component (b1) formed by reacting a compound having the formula R¹ₓSiX_{y}, wherein R¹ is C1-C20 hydrocarbyl, X is halogen, x is an integer between 0 and 3, y is an integer between 1 and 4, and x+y=4, and wherein each X and each R¹ may be the same or different; with at least one compound having the formula R²ₘSi(OR³)ₙ, wherein R² and R³ are independently C1-C20 hydrocarbyl, m is an integer between 0 and 3, n is an integer between 1 and 4, and m+n=4, and wherein each R² may be the same or different and each R³ may be the same or different;
(iii) contacting component (b2) formed by reacting an early transition metal compound having the formula MX₄, wherein X is halogen, M is Ti, Zr, Hf, or V element; with at least one compound having the formula M(OR⁴)₄, wherein R⁴ is C1-C20 hydrocarbyl, and wherein each R⁴ may be the same or different, M is Ti, Zr, Hf, or V element;
(iv) contacting component (b3) containing nitrogen aromatic compound; and
(v) contacting component (b4) having the formula R⁵X, wherein R⁵ is C1-C20 hydrocarbyl or aryl, X is halogen.

The solid magnesium powder used in the present invention has a spherical morphology having particle size of about 50-60 micron. The component (b1) used in the present invention is an organic silicon complex prepared in situ by reacting alkoxysilane ester, R²ₘSi(OR³)ₙ, with halogen-substituted silane, R¹ₓSiX_{y}. The reaction preferably conducted in the presence of magnesium and halogenated alkyl group, such as alkyl chloride, which is believed to form alkyl magnesium halide. The mixture is heated for about 30 to 60 minutes, preferably about 45 to 60 minutes, in a non-polar solvent to about 50 to 100° C., preferably to about 65 to 85° C.

The reactions between alkoxysilane ester with halogen-substituted silane, such as silicon tetrachloride (SiCl₄), are described by M. G. Voronkov, V. P. Mileshevich, and A. Yu in the book “The Siloxane Bond”, Plenum Publishing Corp., New York, 1978. The reaction can be carried out in a non-polar solvent by heating the mixture to about 50 to 100° C., preferably to about 65° C. to 85° C. The duration of heating is not generally critical. One acceptable procedure is to heat for about 30 to 60 minutes once the desired temperature is obtained. The molar ratio of alkoxysilane ester to halogen-substituted silane is from about 0.5 to about 3.0, and more preferably from about 0.8 to about 1.5. Some percentage of the alkoxysilane ester may remain in excess, and thus not reacted, in the final organic silicon product. The organic silicon product is preferably used in the next steps in situ without further separation or characterization.

The halogen-substituted silane has the formula R¹ₓSiX_{y} where R¹ is C₁-C₂₀ hydrocarbyl, which for present purposes includes both unsubstituted and substituted species, including halogen substituted species, X is halogen, x is an integer between 0 and 3, y is an integer between 1 and 4, and x+y=4. More than one halogen X may be employed in the halogen-substituted silane. Suitable halogen-substituted silane compounds include silicon tetrachloride, tetrabromosilane, tetrafluorosilane, benzyltrichlorosilane, bis(dichlorosilyl)methane, 2-bromoethyltrichlorosilane, t-butyldichlorosilane, t-butyltrichlorosilane, 2-(carbomethoxy)ethyltrichlorosilane, 2-chloroethylmethyl dichlorosilane, 2-chloroethyltrichlorosilane, 1-chloroethyltrichlorosilane, chloromethylmethyldichlorosilane, ((Chloromethyl)phenylethyl)trichlorosilane, chloromethyltrichlorosilane, 2-cyanoethylmethyldichlorosilane, cyclohexyltrichlorosilane, cyclopentyltrichlorosilane, cyclotetracmethylenedichlorosilane, cyclotrimethylenedichlorosilane, 1,5-dichlorohexamethyltrisiloxane, (dichloromethyl)trichlorosilane, dichlorosilane, 1,3-dichlorotetramethyldisiloxane, diethyoxydichlorosilane, ethylmethyldichlorosilane, ethyltrichlorosilane, heptyltrichlorosilane, hexachlorodisilane, hexachlorodisiloxane, isobutyltrichlorosilane, methyltrichlorosilane, octyltrichlorosilane, pentyltrichlorosilane, propyltrichlorosilane, and trichloromethyltrichlorosilane. It is preferred to employ tetrachlorosilane, allyltrichlorosilane, ethyltrichlorosilane, methyltrichlorosilane, and dichlorodiphenylsilane.

Suitable alkoxysilane ester compounds have the formula R²ₘSi(OR³)ₙ. R² and R³ are independently any C₁-C₂₀ hydrocarbyl, which for present purposes includes both unsubstituted and substituted species, including halogen substituted species, m is an integer between 0 and 3, n is an integer between 1 and 4, and m+n=4. More than one hydrocarbyl or substituted hydrocarbyl group may be employed as the R² component, and more than one hydrocarbyl or substituted hydrocarbyl group may be employed as the R³ component. Specific alkoxysilane ester compounds include tetramethoxysilane, tetraethoxysilane, tetraisopropoxysilane, tetrapropoxysilane, tetraethoxysilane, tetraisobutoxysilane, tetraphenoxysilane, tetra(p-methylphenoxy)silane, tetrbenzyloxysilane, tetrakis(2-methoxyethoxy)silane, tetrakis(2-ethylhexoxy)silane, tetraallyloxysilane, methyltrimethoxysilane, methyltriethoxysilane, mehtyltributoxysilane, methyltriphenoxysilane, ethyltriethoxysilane, ethyltriisobutoxysilane, ethyltriphenoxysilane, allyltrimethoxysilane, octadecyltrimethoxysilane, octadecyltriethoxysilane, octyltriethoxysilane, phenyltrimethoxysilane, phenyltriethoxysilane, benzyltriphenoxysilane, methyltrialllyloxysilane, dimethyldimethoxysilane, dimethyldiisopropyloxysilane, dimethyldiethoxysilane, dimethyldihexyloxysilane, dimethyldibutoxysilane, dimethyldiphenoxysilane, diethyldiisobutoxysilane, diethyldiethoxysilane, diethyldiphenoxysilane, dibutyldiisopropyloxysilane, dibutyldibutoxysilane, dibutyldiphenoxysilanc, diisobutyldiethoxysilane, diisobutyldiisobutoxysilane, diphenyldimethoxysilane, diphenyldiethoxysilane, diphenyldibutoxysilane, dibenzyldiethoxysilane, divinyldiphenoxysilane, diallyldipropoxysilane, diphenyldiallyoxysilane, 1,1,1,3,3-pentamethyl-3-acetoxydisiloxane, triethoxysilane, trimethoxysilane, triethoxychlorosilane, and trimethoxychlorosilane. Particularly preferable compounds are tetramethoxysilane, tetraethoxysilane, tetraisopropoxysilane, tetrapropoxysilane, tetrabutoxysilane, tetraisobutoxysilane, and combination thereof.

The component (b2) used in the present invention is the early transition metal compounds having the formula M(OR⁴)₄X₄₋ₐ. R⁴ is a C1-C20 hydrocarbyl, X is a halogen, 0≤a≤4, M is Ti, Zr, Hf or V. In the present invention, Ti compound is more preferable, and R⁴ may be unsubstituted or substituted, including halogen substituted. Each R⁴ may be the same or different. The titanium compound Ti(OR⁴)₄X₄₋ₐ may be prepared in situ prepared by reacting a titanium halide compound with Ti(OR⁴)₄ and/or Ti(OR⁴)₃X or by reacting corresponding alcohol, R⁴OH, with a titanium halide compound. Alternatively, Ti(OR⁴)₄X₄₋ₐ may be formed before addition to the reactor by preconditioning a titanium halide compound with Ti(OR⁴)₄, XTi(OR⁴)₃ or R⁴OH. Preconditioning may be achieved by mixing a titanium halide compound in hexane with Ti(OR⁴)₄ or XTi(OR⁴)₃ in hexane and stirring at about 75 to 80° C. for about 0.5 to 1 hour, resulting in a Ti(OR⁴)₄X₄₋ₐ complex.

Examples of the titanium halide compound include TiCl₄, TiBr₄, TiI₄, TiCl₃·nTHF and 3TiCl₃·AlCl₃. Among these titanium halides, TiCl₄ and 3TiCl₃·AlCl₃ are preferred. Titanium compounds with the structural formula Ti(OR⁴)₄ or Ti(OR⁴)₃X include trimethoxymonochlorotitanium, triethoxyfluorotitanium, triethoxychlorotitanium, tetraethoxytitanium, tripropoxyfluorotitanium, tripropoxychlorotitanium, tetra-n-propoxytitanium, tetraisopropoxytitanium, tributoxyfluorotitanium, tributoxychlorotitanium, triisobutoxychlorotitanium, tetra-n-butoxytitanium, tetra-isobutoxytitanium, dipentoxydichlorotitanium, tripentoxymonochlorotitanium, tetra-n-pentyloxytitanium, tetracyclopentyloxytitanium, trioctyloxymonochlorotitanium, 2-ethylhexoxytitanium trichloride, butoxytitanium trichloride, tetra-n-hexyloxytitanium, tetracyclohexyloxytitanium, tetra-n-heptyloxytitanium, tetra-n-octyloxytitanium, tetra-2-ethylhexyloxytitanium, tri-2-ethylhexyloxymonochlorotitanium, tetranonyloxytitanium, tetradecyloxytitanium, tetraisobornyloxytitanium, tetraoleyloxytitanium, tetraallyloxytitanium, tetrabenzyloxytitanium, tetrabenzohydryloxytitanium, triphenoxytitanium, tetr-o-methylphenoxytitanium, tetraphenoxytitanium, tetra-o-methylpheoxytitanium, tetra-m-mchtylphcoxytitanium, tetra-o-methylphenoxytitanium, tetra-m-methylphenoxytitanium, tetra-1-naphthyloxytitanium, tetra-2-napthyloxytitanium and mixtures thereof. The preferred Ti(OR⁴)₄ or Ti(OR⁴)₃X compounds are 2-ethylhexoxytitanium trichloride, butoxytitanium trichloride, tetra-n-propoxytitanium, tetraisopropoxytitanium, tetra-n-butoxytitanium, tetraisobutoxytitanium, dibutoxydichlorotitanium, isobutoxytrichlorotitanium, and propoxytrichlorotitanium.

The component (b3) used in the present invention is pyridine and/or the substituted pyridine. Representative examples of the compounds include pyridine, 2-methylpyridine, 4-methylpyridine, 2-ethylpyridine, 4-ethylpyridine, 4-tert-butylpyridine, 2-[methylamino]methyl]pyridine, 2,6-dimethylpyridine, 2,6-diisopropylpyridine, 2,6-di-tert-butylpyridine, 2-phenyl-6-propyl-pyridine, 2-methyl-6-phenyl-pyridine, 2, 6-trimethylsilyl-pyridine, 2,6-dimethoxypyridine, 2,6-bis(chloromethyl)-pyridine, 2,2′: 6′,2′-terpyridine, 4′-(4-methylphenyl)-2,2′: 6′,2″-terpyridine, and 6,6′-dimethyl-2,2′-dipyridyl.

The component (b3) used in the present invention is preferably employed in amounts sufficient to have a molar ratio of component (b3) to transition metal compound as added in the previous processing step of typically from about 0.01:1 to about 50:1, preferably from about 0.02:1 to about 10:1, and most preferably from about 0.1:1 to about 5:1. Although the conditions are not generally critical, one acceptable procedure is to heat at about 80° C. for about 30 to 100 minutes, preferably about 60 minutes, once the desired temperature is obtained, the solution is generally a dark brown, and can be used for the next steps without further separation or characterization.

The component (b4) used in the present invention is alkyl or aromatic halides compound. Suitable alkyl or aromatic halides have the formula R⁵X, wherein R⁵ is an alkyl group typically containing 3 to 20 carbon atoms or an aromatic group typically containing 6 to 18 carbon atoms and X is halogen, typically chlorine or bromine. Examples of alkyl or aromatic halides include butyl chloride and chlorobenzene.

The catalyst precursor (A) for olefin polymerization can be obtained by contacting magnesium with components b1-b4 as described above. Specifically, the magnesium halide composite support is in situ prepared by reacting metallic magnesium with an alkyl halide or aromatic halide (b4) in the presence of the components b1-b3 at a temperature of about 75 to 90° C., preferably about 75 to 80° C. for about 3-6 hours. The molar ratio of alkyl or aromatic halide (b4) to metallic magnesium is about 1.0 to about 4.0, preferably about 2.0 to about 2.5. The ratio of the component (b3) to metallic magnesium is about 0.01 to about 1.0, and preferably about 0.05 to about 0.5. The ratio of the component (b2) to metallic magnesium is about 0.15 to about 1.0, and preferably about 0.25 to 0.50. The ratio of the component (b1) to metallic magnesium is about 0.25 to about 2.0, and preferably about 0.5 to about 1.5.

The catalyst precursor (A) for olefin polymerization is prepared in a non-polar solvent. Suitable non-polar solvents are materials in which all of the reactants used herein (e.g., the silicon compound, the transition metal compound, and electron donors) are at least partially soluble and which are liquid at reaction temperatures. Preferred non-polar solvents are saturated hydrocarbons and include alkanes, such as isopentane, hexane, heptane, octane, nonane, and decane. A nitrogen atmosphere may be used to prevent exposure to air. The catalyst precursor (A) may be stored in a slurry state under nitrogen for further prepolymerization or dried into powder for further prepolymerization to prepare prepolymerized catalysts for olefin polymerizaiton.

The prepolymerized catalyst for olefin polymerization according to the present invention can be obtained by polymerizing (prepolymerizing) a small amount of olefin using the above-described catalyst precursor (A) for olefin polymerization, and activators formed by contacting the mixture of cocatalysts with an electron donative compound.

The cocatalyst of the present invention are aluminum compounds including, but not limited to, triethylaluminium (TEAL), trimethylaluminum (TMA), tri(n-propyl)aluminum, tri(isopropyl)aluminum, tri(n-butyl)aluminum, tri(isobutyl)aluminum, Tri(t-butyl)aluminum, trihexylaluminum (THAL), tri(n-octyl)aluminum (TnOA), dimethyl aluminum chloride (DMAC), diethyl aluminum chloride (DEAC), diisobutyl aluminium chloride, ethyl aluminum dichloride (EADC), ethylaluminium sesquichloride (EASC), methyl aluminum dichloride, and alkylaluminoxane or mixtures therefrom, or an organohalogenous aluminum compound in-situ prepared by reacting alkyl aluminum and/or alkylaluminoxane with halogenated alkylaluminum compounds.

Alkylaluminoxane, such as methylaluminoxane (MAO), have been widely used to activate metallocene catalysts or single-site catalysts for producing m-LLDPE, but have not been employed to activate Ziegler-Natta catalyst in the prior art. Rather, halogenated alkylaluminum compounds including DMAC, DEAC, EADC, and EASC have been used to activate Ziegler-Natta catalyst. As is well known in the art, when using halogenated alkylaluminum compounds as cocatalyst, Ziegler-Natta catalysts demonstrate very low activity. When using a combination of halogenated alkylaluminum compound, such as EADC and triethyl aluminum (TEAL) (as described in U.S. Pat. Nos. 6,043,326 and 8,546,499, each of which is incorporated herein in its entirety), was found that SiO₂-based Ziegler-Natta catalysts have good activity, improved short chain branching distribution, and reduced soluble extraction. However, the prior art fails to address the processability and melt strength, physical properties (dart impact and tear strengths), and optical properties (haze, clarity and gloss) of the product. More importantly, when using a combination of halogenated alkylaluminum compound such as EADC or DEAC or and alkylaluminoxane such as methylaluminoxane (MAO) in the present invention, it was discovered that the composition of ethylene/alpha-olefins copolymer or linear low density polyethylene is much different from that reported in U.S. Pat. Nos. 6,043,326 and 8,546,499, according to analysis from CRYSTA and TREF techniques. Moreover, the Ziegler-Natta catalyzed ethylene/alpha-olefins copolymer of the present invention has sporadic long chain branches and reversed comonomer composition distribution or short chain branching distribution (SCBD) in the low-soluble fraction at elution temperature of about 30° C. and high molecular weight tail (fraction) obtained from an elution temperature range from about 100° C. to about 130° C. The composition of ethylene/alpha-olefins copolymer or linear low density polyethylene provided in this invention is also substantially different from that reported in assignee's prior patents, such as U.S. Pat. Nos. 8,993,693, and 9,487,608.

Preferred cocatalysts of the present invention are EASC or EADC or DEAC, which can be used preferably in combination with methylaluminoxane (MAO).

If methylaluminoxane (MAO) is used in combination with EASC or EADC or DEAC, it is believed an organohalogenous compound may be in-situ produced by reacting alkylaluminoxane with halogenated alkylaluminum compounds, which is used as cocatalyst in Ziegler-Natta catalysts, the corresponding polymer prepared has a sporadic long chain branches in high molecular weight fractions and a high molecular weight tail along with reversed comonomer composition distribution for improving processability, melt strength, and optical properties.

Activation of the catalyst precursor (A) is conducted with an activator in-situ formed by contacting the mixture of cocatalysts, comprising alkylalumoxane (B) and halogenated alkylaluminum (C), with R₃Si—NH—SiR₃-type disilazanes (D).

A typical reaction used to prepare the organoaluminum compound by mixing cocatalysts alkylalumoxane (B) and alkylaluminum dihalide (C) is described in the following equation:

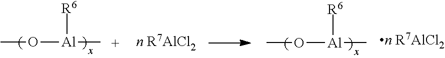

wherein the alkylalumoxane (B) may be oligomeric linear and/or cyclic alkylaluminoxanes, R⁶ is C₁-C₂₀ hydrocarbyl, which for present purposes includes both unsubstituted and substituted species, including substituted species with halogen, alkoxide and hydride, and x is 1-40, preferably 3-20. The representative example of alkylaluminoxane used in prepolymerization is selected from methylalumoxane, modified methylalumoxane, tetraethyldialumoxane, tetrabutylalumoxane, bis(diisobutylaluminum) oxide, ethylalumoxane, isobutylalumnoxane, and polymethylalumoxane, and mixtures or combinations of thereof, and more preferably modified methylalumoxane.

R⁷ is C₁-C₂₀ hydrocarbyl, which for present purposes includes both unsubstituted and substituted species, including substituted species with halogen, alkoxide and hydride; n is typically 0.05 to 20, preferably 0.5 to 2. The mixing temperature between the alkyalumoxane and alkylaluminium dichloride is typically from about −10° C. to about 85° C., and preferably from about 20° C. to about 60° C. The suitable alkylaluminum dihalides used in prepolymerization include methylaluminum dichloride, ethylaluminum dichloride, isobutylaluminum dichloride, isobutylaluminum dichloride, t-butylaluminum dichloride, and amylaluminum dichloride, with ethylaluminum dichloride being more preferable.

The alkylaluminum dihalide (C) may be prepared in situ via the reaction between aluminum trihalide and dialkylaluminum halide. Suitable aluminum trihalide includes aluminum trichloride, aluminum tribromide and aluminum triiodide, with aluminum trichloride being more preferable. Suitable example of dialkylaluminum is selected from dimethylaluminum chloride, diethylaluminium chloride, diisobutylaluminum chloride, di(t-butyl)aluminum chloride, and diamylaluminum chloride, with diethylaluminum chloride being more preferable.

The alkylaluminum dihalide (C) may also be prepared in situ via the reaction between alkene and dihaloaluminum hydride. The suitable dihaloaluminum hydride is selected from dichloroaluminum hydride, dibromoaluminum hydride, and diiodoalumminum hydride, with dichloroaluminum hydride being more preferable. The examples of alkene contains a C1-20 alkyl group with or without substitute species of halogen, alkoxide and hydride.

Among the aforementioned mixture and combination of cocatalysts, the mixture of modified methylalumoxane and ethylaluminum dichloride is most preferred. In one embodiment, the said cocatalysts could be mixed prior to adding to the supported catalyst component for activation. In another embodiment, the said cocatalysts could separately be added to the supported catalyst component for activation.

R₃Si—NH—SiR₃-type disilazanes (component D) are a group of compounds containing a direct silicon-nitrogen bond (e.g., hexamethyldisilazane, tetramethyldisilazane, etc.), which can be easily cleaved and finally resulted in their usefulness as the source of nitrogen (e.g., multicomponent reactions) or silicon (e.g., O-silylation). While the use of these disilazanes as silylating agents is well-known, the incorporation of their nitrogen into organic molecules offers immense, but still unexplored opportunities in chemistry. Assignee's prior patents, such as U.S. Pat. Nos. 10,344,105, and 11,952,445, describe the process for making polyethylene copolymers by using a mixed cocatalyst from TEAL/EADC or TnOA/DMAC or MAO/EADC. However, reactor fouling and poor operability in gas phase reactor was observed, which results in lower production rate and reactor shutdown frequently. The activator provided in the present invention, which is in-situ formed by contacting the mixture of TEAL/EADC or TnOA/DMAC or MAO/EADC with R₃Si—NH—SiR₃-type disilazanes, can improve the operability of polymerization, and is capable of preventing fouling of olefin polymer particles to a polymerization reactor.

Suitable disilazanes (component D) have the formula R⁸₃Si—NH—SiR⁹₃. R⁸ and R⁹ are either same or different, independently hydrogen or any C₁-C₂₀ hydrocarbyl and aryl. Representative examples of the disilazanes include 1,1,1,3,3,3-hexamethyldisilazane (HMDS) and 1,1,3,3-tetramethyldisilazane (TMDS), 1,3-divinyl-1,1,3,3-tetramethyldisilazane, various 1,3-dichlorodisilazanes, 1,1,1-trimethyl-3,3,3-triphenyldisilazane, 1,1,3,3-tetramethyl-1,3-divinyldisilazane, 1,1,3,3-tetramethyl-1,3-diphenyldisilazane, and 1,3-dimethyl-1,1,3,3-diphenyldisilazane.

The supported catalyst precursor (A) is activated with an activator in-situ formed by contacting the mixture of cocatalysts alkylalumoxane (B)/alkylaluminum dihalide (C) with R₃Si—NH—SiR₃-type disilazanes (component D). The molar ratio of the aluminum of the activator to the titanium of the catalyst precursor is 0.05 to 500. The activator may be in situ formed by sequentially adding the alkylalumoxane (B), alkylaluminum dihalide (C), and R₃Si—NH—SiR₃-type disilazanes (component D) separately to the polymerization medium, before introducing catalyst precursor to polymerization medium. The catalyst precursor may be in-situ activated by adding the activator and catalyst precursor separately to the polymerization medium. It is also possible to combine the catalyst precursor and the activator before their introduction into the polymerization medium, for example for 2 hours or less and at a temperature from −10 to 85°, and preferably 20 to 60° C.

The organoaluminum compound, formed by contacting alkylalumoxane (B) with alkylaluminum dihalide (C), is used in a ratio of about 0.1 to 100, preferably about 0.5 to 50, calculated as the Al/Ti atomic ratio, that is, the atomic ratio of the Al atom in the organoaluminum compound to the Ti atom in the solid catalyst component. The more preferred ratio is about 2 to about 10. The prepolymerized catalyst is obtained without removing fine particles from the resultant prepolymerized catalyst particles. In the present invention, the fine particles are particles having a particle size of not more than D¹ present in the prepolymerized catalyst for olefin polymerization.

The olefin used in prepolymerization may include ethylene, propylene, 1-butene, 1-pentene, 1-hexene, 1-octene, 4-methyl-1-penpene, cyclopentene, cyclohexene and the like. These can be used singly or in combination of two or more. Preferably, ethylene is singly used or ethylene and alpha-olefin are used together, further preferably, ethylene is singly used or ethylene and at least one alpha-olefin selected from 1-butene, 1-hexene and 1-octene are used together.

The content of the prepolymerized polymer in the prepolymerized catalyst for olefin polymerization is preferably from about 0.01 to about 1000 g, more preferably from about 0.05 to about 500 g and most preferably from about 1.0 g to about 200 g, usually per gram of catalyst precursor.

The method of prepolymerizing a catalyst component for olefin polymerization may be continuous or batch-wise, and examples thereof include a batch-wise slurry polymerization method, continuous slurry polymerization method and continuous gas phase polymerization method. As the method of charging a catalyst component into a polymerization reactor for carrying out prepolymerization, a method of changing under anhydrous state using an inert gas such as nitrogen, argon and the like, and hydrogen, ethylene and the like, and a method in which components are dissolved in or diluted with a solvent and charged in the form of solution or slurry, are usually used.

In the case of conducting prepolymerization by a slurry polymerization method, saturated aliphatic hydrocarbon compounds are usually used as the solvent, and examples thereof include propane, n-butane, isobutene, n-pentane, isopentane, n-hexane, cyclohexane, heptane and the like. These are used singly or in combination of two or more. As the saturated aliphatic hydrocarbon compound, those having a boiling point of about 100° C. or less at normal pressure are preferable, those having a boiling point of about 90° C. or less at normal pressure are more preferable, and propane, n-butane, isobutene, n-pentane, isopentane, n-hexane and cyclohexane are further preferable.

In the case of conducting prepolymerization by a slurry polymerization method, the slurry concentration is usually about 0.1 to about 600 g, preferably about 1.0 to about 500 g, in terms of the amount of a polyethylene per liter of a solvent. The prepolymerization temperature is usually about 0 to about 100° C., preferably about 0 to about 80° C., and more preferably about 45 to about 75° C. During prepolymerization, polymerization temperature may be changed appropriately. The partial pressure of olefins in a gas phase portion during the prepolymerization is usually about 0.1 to about 20 bar, preferably about 1.0 to about 10 bar. Hydrogen is an important factor affecting the properties of prepolymerized catalyst such as bulk density, powder flow ability, and even the catalytic activity. The ratio of hydrogen to ethylene may typically be about 0.01 to about 10.0, and preferably about 0.05 to about 1.0. The hydrogen could be charged either only at the beginning of reaction or continually during the reaction. The prepolymerization time is usually is usually 1 about 0 minutes to about 15 hours. Drying of prepolymerized catalyst particles can be carried out using conventionally known drying apparatuses equipped with hot nitrogen flush and solvent condensation system.

It is unnecessary to remove fine particles from prepolymerized catalyst particles for olefin polymerization, but is necessary to lower the content of fine particles in prepolymerized catalyst particles, and is necessary to regulate the content of fine particles to about 10% by weight or less, thereby obtaining a prepolymerized catalyst according to the present invention. In the present invention, the fine particles are particles having a particle size of not more than D¹ described above present in the prepolymerized catalyst for olefin polymerization.

Catalyst components for olefin polymerization before prepolymerization of an olefin are classified by elutriation method, which is a process for separating particles based on their size, shape and density, using a steam of liquid flowing in a direction usually opposite to the direction of sedimentation. Therefore, a prepolymerized catalyst for olefin polymerization has a good morphology.

When the prepolymerized catalyst is used for gas phase polymerization, the prepolymerized catalyst according to present invention may be combined with inert diluents to form slurry, or dried to obtain a free-flowing powder. The drying temperature is typically from about 30° C. to 80° C., and preferably from about 40° C. to 60° C. The average particle size of the prepolymerized catalyst is typically from about 180 to 350 micron or less, more preferably from about 200 to 300 micron. In addition, small amounts of fine particles (typically <80 micron) may also be produced. The typical fine particle content is from about 2 to about 12%, and preferably from about 5 to about 10%. High content of fine particles in the prepolymerized catalyst could bring about issues of high static and hot spots, and should be avoided in the gas phase polymerization. The MI or I₂ of the ethylene prepolymer is typically from about 0.01 to about 100 g/10 min, and preferably from about 0.5 to about 5 g/10 min. The solid powder of the prepolymerized catalyst can be stored under nitrogen for a relatively long period time, typically from about two weeks to a month, and maintain good activity in the following slurry or gas phase polymerization.

The method of producing an olefin polymer according to the present invention comprises polymerization of an olefin using the above-described prepolymerized catalyst for olefin polymerization according to the present invention. In the present invention, the polymerization includes not only homopolymerization but also copolymerization, and the polymer includes not only a homopolymers but also a copolymer. The olefin used in olefin polymerization may be the same as or different from the olefin to be used in the above-described prepolymerization, and a plurality of olefins may be used in combination.

The olefin to be used for polymerization includes olefins having 2 to 20 carbon atoms such as ethylene, propylene, 1-butene, 1-pentene, 1-hexene, 1-octene, 1-nonene, 1-decene, 1-dodecene, 4-methyl-1-pentene, 4-methyl-1-hexene and the like. These may be used singly or in combination of two or more. Preferable are ethylene, 1-butene, 1-hexene, 4-methyl-1-pentene and 1-octene.

The method of producing an olefin polymer according to the present invention is suitable for copolymerization of ethylene and an alpha-olefin having 3 to 20 carbon atoms, and the combination of ethylene and an alpha-olefin includes ethylene/1-butene, ethylene/1-hexene, ethylene/4-methyl-1-pentene, ethylene/1-octene, ethylene/1-butene/1-hexene, ethylene/1-butene/4-methyl-1-pentene, ethylene/1-butene/1-octene, ethylene/1-hexene/1-octene, and the like, preferably ethylene/1-hexene, ethylene/4-methyl-1-pentene, ethylene/1-butene/1-hexene, ethylene/1-butene/1-octene, and ethylene/1-hexene/1-octene.

In the present invention, the olefin polymerization method includes a gas phase polymerization method, slurry polymerization method, bulk polymerization method and the like. A gas phase polymerization method is preferable, and a continuous gas phase polymerization method is more preferable. A preferred method for producing LLDPE resins is a gas phase process, including stirred bed reactors and fluidized bed reactors. No additional cocatalyst is added in the polymerization of alpha-olefins to produce olefin polymers using an inventive prepolymerized catalyst produced by the above-described production method.

Standard polymerization conditions for producing polyolefin polymers by the method of the present invention, such as the polymerization temperature, polymerization time, polymerization pressure, monomer concentration and hydrogen concentration should be selected. Typically, the polymerization temperature should be below the sintering temperature of polymer particles for gas phase polymerization. For the production of ethylene copolymers, an operating temperature of about 30° C. to 115° C. is acceptable, about 50° C. to 100° C. is preferred, and about 75° C. to 95° C. is more preferred. Temperatures of about 75° C. to 90° C. are preferably used to prepare LLDPE products having a density of about 0.90 to about 0.92 g/mL; temperatures of about 80° C. to 100° C. are preferably used to prepare LLDPE products having a density of about 0.92 to about 0.94 g/mL; and temperatures of about 90° C. to 115° C. are used to prepare LLDPE products having a density of about 0.94 to about 0.96 g/mL. Molecular weight of the polymers may be suitably controlled with hydrogen when the polymerization is performed using the catalyst system of the present invention described herein. The control of molecular weight may be illustrated by changes in melt indexes (I₂ and I₂₁) of the polymer.

Copolymerizing the alpha-olefin comonomers with ethylene to achieve about 1 to 5 mol percent of the comonomer in the copolymer results in the desired density ranges in the copolymers. The amount of the comonomer needed to achieve this result will depend on the particular comonomer(s) employed. It has been found that when using a gas phase catalytic polymerization reaction, 1-butene, 1-hexene and 4-methyl-1-pentene can be incorporated into ethylene-based copolymer chains with high efficiency. A relatively small concentration of 1-butene, 1-hexene or 4-methyl-1-pentene in the gas phase reactor can lead to a relatively large incorporation of 1-butene, 1-hexene or 4-methyl-1-pentene into the resulting copolymer. For example, 1-butene, 1-hexene or 4-methyl-1-pentene in an amount up to about 18 percent by weight, preferably about 2 to about 12 percent by weight, may produce LLDPE resins having a density of less than about 0.940 g/mL.

LLDPE resins may be copolymers of ethylene with one or more C₃-C₁₀ alpha-olefins. Thus, copolymers having two types of monomer units are possible as well as terpolymers having three types of monomer units. Particular examples of such polymers include, but are not limited to, ethylene/1-butene copolymers, ethylene/1-hexene copolymers, ethylene/4-methyl-1-pentene copolymers, ethylene/propylene/1-butene terpolymers, ethylene/propylene/1-hexene terpolymers, ethylene/1-butene/1-hexene terpolymers. Particularly preferred comonomers are 1-hexene, 4-methyl-1-pentene, propylene, 1-butene, and mixtures thereof.

According to the method of producing an olefin polymer according to the present invention, an olefin can be polymerized stably and continuously without causing problems such as agglomeration of a prepolymerized catalyst for olefin polymerization in a polymerization reactor, blockage of a cyclone, and the like, since an olefin is polymerized using the prepolymerized catalyst for olefin polymerization according to the present invention.

The copolymer produced in accordance with the present invention may have a density of about 0.960 g/mL or less, preferably about 0.952 g/mL or less, or more preferably about 0.940 g/mL or less. Density was measured according to ASTM D1505-98. In accordance with certain aspects of the present invention, it is possible to achieve densities of less than about 0.910 g/mL and even as low as about 0.870 g/mL. Copolymer resins produced in accordance with the present invention preferably contain at least about 75 percent by weight of ethylene units. Preferably, the copolymer resins of the present invention contain at least about 0.5 weight percent, for example, from about 0.5 to about 25 weight percent of an alpha-olefin.

The molecular weight of the copolymers may be controlled in a known manner, preferably by using hydrogen. With the catalysts produced according to the present invention, molecular weight may be suitably controlled with hydrogen when the polymerization is carried out at temperatures from about 20 to 300° C. This control of molecular weight may be evidenced by a measurable positive change of the melting index (I₂). Melt flow index (MI) of the polymer was measured at 190° C., according to ASTM D1238. Melt flow ratio (MFR), which is the ratio of high melt flow index (HLMI or I₂₁) to melt index (MI or I₂), was used as measure of melt fluidity and a measure of the molecular weight distribution.

The molecular weight distribution (MWD) of the polymers prepared according to the present invention, as expressed by the MFR values, varies from about 10-40. MFR is the ratio of the high-load melt index (HLMI or I₂₁) to the melt index (MI or I₂) for a given resin (MFR=I₂₁/I₂). The ethylene/1-hexene copolymer having a density of about 0.910 g/mL to about 0.930 g/mL, in a preferred embodiment, has a melt index ratio (I₂₁/I₂) of between about 20 and about 30.

Molecular weights and molecular weight distribution were measured by Gel Permeation Chromatography (GPC). The polymers of the present invention have a molecular weight distribution, a weight average molecular weight to number average molecular weight (M_{w}/Mₙ), of from about 2.5 to about 6.0, preferably from about 2.5 to about 4.5, more preferably from about 3.0 to about 4.0, and most preferably from about 3.2 to about 3.8. The polymers have a ratio (M_{z}/M_{w}) of z-average molecular weight (M_{z}) to weight average molecular weight of greater than about 2.5. In one embodiment, this ratio is from about 2.5 to about 3.8. In yet another embodiment, this ratio is from about 2.5 to about 3.5. The ratio of z-average molecular weight to weight average molecular weight (M_{z}/M_{w}) reflects inter- and/or intra-macromolecular entanglement and unique polymer rheological behavior.

Molecular weight measurements were carried out using a high temperature size exclusion chromatograph (SEC) (Polymer Char) equipped with a differential refractive index (DRI) and infrared (IR) (PolyChar, IR4) detectors, a Viscotek model 210R viscometer, and a multi-angle laser light scattering (MALLS) apparatus (Wyatt, DAWN EOS). All measurements were taken at 145° C. using 1,2,4-trichlorobenzene (TCB) as the solvent. The system was calibrated with a standard material (NBS 1475) with a weight-average molecular weight of 52000 g/mol and an intrinsic viscosity of 1.01 dL/g. The refractive index increment, dn/dc, was calculated from the calibrated DRI detector as 0.11 mL/g. Molecular weights for the polyethylene polymers of the present invention were calculated from the intrinsic viscosity detector using the following Mark-Houwink parameters; K=4.5×10⁻⁴ dL/g and a=0.735, established for linear polyethylene from a polystyrene calibration.

SEC with the multiple detectors can detect differences between the hydrodynamic volume of linear and branched polymers. Simultaneous measurement of intrinsic viscosity [η], and absolute molecular weight, Mis, for each fraction of polymer separated by the chromatography columns can provide information about the structure of branched polymers. Mark-Houwink plots (log [η] vs log [M_{w}]) for each slice of the SEC elution, can be used to qualitatively observe branching. The linear standard polyethylene polymers behave in a fashion described by the Mark-Houwink relation: [η]=KM^{a}, where K and a can be obtained from the slope and intercept of the Mark-Houwink plot. However, branched polymers begin to deviate from linear behavior at high molecular weights, that is, the slopes of the Mark-Houwink plot for the branched polymer deviate from that of the linear standard. The deviation from linear behavior is subtle at low branch point density but became more apparent as branch point density is increased. In accordance with certain teachings of the present invention, this deviation from linear behavior is observed in the high molecular weight fractions of the inventive samples, that is, the inventive samples have long branched polymer chains. In contrast, the comparative samples conform to the linear relationship of Mark-Houwink plot in all the molecular weight fractions, indicating they do not contain any long chain branching in the polymers. SCBD data can be obtained using a SEC-FTIR high temperature heated flow cell (Polymer Laboratories) as reported in the literature (P. J. DesLauriers, D. C. Rohlfing, and E. T. Hsich, Quantifying short chain branching microstructures in ethylene 1-olefin copolymers using size exclusion chromatography and Fourier transform infrared spectroscopy (SEC-FTIR) Polymer, 2002, 43, 159).

Analytical Temperature Rising Elution Fractionation (TREF) technique was carried out on a PolyChar TREF 200+ instrument. 40 mg of polymer sample and 20 mL of 1,2,4-trichlorobenzene were sequentially charged into the vessel to dissolve the polymer. Then, an aliquot of the resulting polymer solution was loaded on the column and cooled at about 0.5° C./min to 35° C. Afterward, the elution began using a 0.5 mL/min flow rate and heating at about 1° C./min up to 140° C.

Comonomer distribution breadth index (CDBI), defined as the weight percent of the ethylene copolymer having a comonomer content within 50 percent of the median total molar comonomer content, can be calculated by the data obtained from TREF, as described in the literature (L. Wild., T. R. Ryle, D. C. Knobeloch, and I. R. Peat, Determination of branching distributions in polyethylene and ethylene copolymers J. Polym. Sci. Polym. Phys. Ed., 1982, 20, 441).

CRYSTAF is a fully automated instrument intended for the fast measurement of the Chemical Composition Distribution (CCD) in Polyolefins. CRYSTAF instrument performs the Crystallization Analysis Fractionation technique to separate the polymer by its comonomer content. The polymer is initially dissolved in an appropriate solvent at an increased temperature, and then the temperature of solution is reduced very slowly resulting in gradual crystallization of the polymer. The process is done in a single temperature ramp (crystallization step), while the polymer solution concentration is monitored by using the Infrared Detector IR4 of Polymer Char. CRYSTAF can be converted into a CRYSTAF-TREF combined system capable of running both techniques by using the same hardware. Each technique can provide complementary information on the CCD in some complex resins.

The copolymers produced in accordance with the present invention may also be blended with additives to form compositions that can then be used in articles of manufacture. Those additives include antioxidants, nucleating agents, acid scavengers, plasticizers, stabilizers, anticorrosion agents, blowing agents, other ultraviolet light absorbers such as chain-breaking antioxidants, etc., quenchers, antistatic agents, slip agents, pigments, dyes and fillers and cure agents such as peroxide. These and other common additives in the polyolefin industry may be present in polyolefin compositions from about 0.01 to about 50 wt % in one embodiment, and from about 0.1 to about 20 wt % in another embodiment, and from about 1 to about 5 wt % in yet another embodiment.

In particular, antioxidants and stabilizers such as organic phosphites and phenolic antioxidants may be present in the polyolefin compositions from about 0.001 to about 5 wt % in one embodiment, and from about 0.02 to about 0.5 wt % in yet another embodiment. Non-limiting examples of organic phosphites that are suitable include tris(2,4-di-tert-butylphenyl)phosphite (IRGAFOS 168) and tris(nonyl phenyl)phosphite (WESTON 399). Non-limiting examples of phenolic antioxidants include octadecyl 3,5-di-t-butyl-4-hydroxyhydrocinnamate (IRGANOX 1076) and pentaerythrityl tetratris(3,5-di-tert-butyl-4-hydroxyphenyl)propionate (IRGANOX 1010); and 1,3,5-tri(3,5-di-tert-butyl-4-hydroxybenzyl-isocyanurate (IRGANOX 3114).

Fillers and fatty acid salts may also be present in the polyolefin including LLDPE composition. Filler may be present from about 0.1 to about 65 wt % in one embodiment, and from about 0.1 to about 45 wt % of the composition in another embodiment, and from about 0.2 to about 25 wt % in yet another embodiment. Desirable fillers include, but are not limited to, titanium dioxide, silicon carbide, silica (and other oxides of silica, precipitated or not), antimony oxide, lead carbonate, zinc white, lithopone, zircon, corundum, spinel, apatite, Barytes powder, barium sulfate, magnesiter, carbon black, dolomite, calcium carbonate, talc and hydrotalcite compounds of the ions Mg, Ca, or Zn with Al, Cr or Fe and CO₃⁻ and/or HPO₄, hydrated or not; quartz powder, hydrochloric magnesium carbonate, glass fibers, clays, alumina, and other metal oxides and carbonates, metal hydroxides, chrome, phosphorous and brominated flame retardants, antimony trioxide, silica, silicone, and blends thereof. These fillers may particularly include any other fillers and porous fillers and supports known in the art.

Fatty acid salts may be present from about 0.001 to 6 wt % of the composition in one embodiment, and from about 0.01 to about 2 wt % in another embodiment. Examples of fatty acid metal salts include lauric acid, stearic acid, succinic acid, stearyl lactic acid, lactic acid, phthalic acid, benzoic acid, hydroxystearic acid, ricinoleic acid, naphthenic acid, oleic acid, palmitic acid, and erucic acid, suitable metals including Li, Na, Mg, Ca Sr, Ba, Zn, Cd, Al, Sn, Pb and so forth. Preferred fatty acid salts include magnesium stearate, calcium stearate, sodium stearate, zinc stearate, calcium oleate, zinc oleate, and magnesium oleate.

In the physical process of producing the blend of polyolefin and one or more additives, sufficient mixing should take place to assure that a uniform blend will be produced prior to conversion into a finished product. The polyolefin can be in any physical form when used to blend with the one or more additives. In one embodiment, reactor granules, defined as the granules of polymer that are isolated from the polymerization reactor, are used to blend with the additives. The reactor granules have an average diameter of from about 10 μm to about 5 mm, and from about 50 μm to about 10 mm in another embodiment. Alternately, the polyolefin is in the form of pellets, such as, for example, having an average diameter of from about 1 mm to about 6 mm that are formed from melt extrusion of the reactor granules.

One method of blending the additives with the polyolefin is to contact the components in a tumbler or other physical blending means, the polyolefin being in the form of reactor granules. This can then be followed, if desired, by melt blending in an extruder. Another method of blending the components is to melt blend the polyolefin pellets with the additives directly in an extruder, Brabender or any other melt blending means.

Rheological tests were carried out on compression molded disk of the polymer pellets in an ARES-G2 Rheometer (TA Instrument) using parallel plate geometry. Small strain (3%) dynamic mechanical experiments were performed at 190° C. in a nitrogen atmosphere. The resulting complex viscosity as a function of imposed oscillatory frequency (|η*| vs. ω) was then curve fitted with modified three parameter Carreau-Yasuda (CY) empirical model:

$$\vert {η}^{*} ( ω ) \vert = {η}_{0} / {[ 1 + {( {τ}_{η} ω )}^{a} ]}^{( 1 - n ) / a} ,$$

to obtain the zero shear viscosity (ηₒ), characteristic viscous relaxation time (τ_{η}) and the breadth parameter (a). Due to the limitation of the measurement range, n is taken as 0.1818 based on theoretical value. (Graessley W. W. Viscosity of Entangling Polydisperse Polymer, J. Chem. Phys. 1967, 47, 1942-1953)

The Janzen-Colby model was used for characterizing the long chain branching effect on polymer melt viscosity (J. Janzen and R. H. Colby, Diagnosing long-chain branching in polyethylenes, Journal of Molecular Structure 1999, 485-486, 569-584). The long chain branch content (vertexes per a million carbons) was denoted as J-C α value. For the cases with polymer dispersity of ≥2.0, a small correction based on Yau's article (Wallace W. Yau, A rheology theory and method on polydispersity and polymer long-chain branching, Polymer 2007, 48, 2362-2370) was also required to offset the effect of molecular weight breadth.

The date of storage modulus (G′) and loss modulus (G″) as a function of shear rate (y) can also be obtained using Cox-Merz rule. Melt strength index (MSI), defined as the ratio of storage modulus and loss modulus (G′/G″) at a shear rate of 0.03 s⁻¹, is used as an empirical parameter for evaluating melt quality in the film blowing process. In accordance with the present invention, MSI value is between about 0.01 and about 0.80.

The polymers produced according to the present invention are more easily extruded into film products by cast or blown film processing techniques as compared to commercial octene-1 LLDPE and commercial mLLDPE (I) with comparable melt index and density. The resins in this invention have, for a comparable MI, a MWD narrower than 1-hexene copolymer resins but broader than mLLDPEs. The resins made from this invention also exhibit a molecular structure, such as comonomer composition distribution, similar to typical mLLDPE resins.

More specifically, in the present invention, the polymer powder was screened and dry-blended with suitable additives such as Irganox-1076 (available from Ciba-Geigy), TNPP, Polybloc Talc, zinc stearate and Erucamide, in a Henschel mixer. The compounded polymer resins are extruded through a single screw laboratory extruder and blown into film under the following conditions: BUR=2.5:1, gauge=1 mil, melt temperature=425° F. Film dart impact (g/mil) was tested by ASTM D-1709, and film Elmendorf Tear (g/mil) by ASTM D-1922 and secant modulus by ASTM D-882, film haze by ASTM D-1003, film clarity by ASTM D-1746, and gloss by ASTM D-2457.

### EXAMPLES

### Example 1

### Synthesis of a Magnesium-Based Supported Catalyst Precursor (Component A)

Anhydrous hexane (2 L), magnesium (31.9 g), iodine (3.3 g), 2-methyl-1-propanol (5.0 mL), titanium propoxide (7.2 mL) and butyl chloride (5.0 mL) were successively charged into a 5 L reactor equipped with an anchor stirrer driven by a magnetic motor. The reactor was heated to 85° C. within 60 minutes and then cooled to 80° C. within 20 minutes. Tetraethoxy orthosilicate (20 mL) and silicon tetrachloride (40 mL) were added to the reactor and held at 80° C. for 40 minutes to yield a yellow-brown reaction product in the suspension. Next, titanium propoxide (38.9 mL) and TiCl₄ (18.3 mL) were charged to the suspension at 80° C., and the slurry mixture was stirred for 0.5 hour to yield organic silicon complex containing titanium, followed by the slow introduction of 2,6-dimethylpyridine (16.0 mL) in the suspension. The reaction was stirred at 80° C. for 1 hour to yield a brown/yellow reaction product, which was used without further separation. Then n-butyl chloride (40 mL) was added at the rate of 0.96 mL/min and held for 4 hours. The suspension was cooled to 50° C., resulting in a brownish precipitate, which was subsequently washed 3 times with 2 L hexane at 50° C. Drying the precipitate led to a solid magnesium-based supported titanium catalyst precursor. Analysis shows that the supported catalyst precursor composition contains 7.0 wt % Ti, 1.5 wt % Si and 14.5 wt % Mg.

### Synthesis of Prepolymerized Catalyst

Two liters of n-hexane, 50 mmoles of DMAC, 90 mmoles of mMAO (the modified MAO containing isobutylalumnoxane was purchased from Nouryon—CAS #146905-79-5, mMAO-3A 7 wt % AL in Heptane), and 25 mmoles of the 1,1,1,3,3,3-hexamethyldisilazane (HMDS) into a 5 liter stainless steel reactor under nitrogen atmosphere, provided with a stirring device rotating at 750 rpm and heated to 50° C. for 30 minutes. A previously prepared catalyst precursor (A) containing 12.6 mmoles of titanium were then introduced into a 5 liter stainless steel reactor containing activator in-situ formed described above under nitrogen atmosphere. Reactor was continuously stirred at 750 rpm and heated to 60° C. Hydrogen was then introduced to obtain a partial pressure of 0.5 bar, and ethylene was introduced at a steady flow rate of 160 g/h for 3 hours at 68° C. Subsequently, the reactor was degassed and its contents were transferred into a flask evaporated in which the hexane was removed under vacuum followed by nitrogen heating to 40-50° C. After evaporation, 480 g of prepolymer containing 45.0 g polyethylene per mmoles of titanium and Al/Ti ratio of 2.5 were obtained as a pre-polymerized catalyst. The prepolymerized catalyst was stored under nitrogen and would be used for the sequential gas phase polymerization. The yield of ethylene polymer in the prepolymerized catalyst falls into the typical range of 40-50 g PE/mmol Ti. The average particle size is controlled in the range of 220-250 mcrons, while fine particle (80 micron) less than 10 wt %. Small amount of the prepolymerized catalyst was taken to be deactivated with water and then washed with hexane prior to being used for property test, as showed in Table 1.

### Gas Phase Copolymerization of Ethylene and 1-Hexene

Co-polymerization was carried out in an 8 liter autoclave designed for stirred gas phase polymerization, equipped with an anchor stirrer with magnetic stirrer drive above the top of autoclave and a valve at the base of the autoclave to withdraw polymer. The temperature was regulated using steam/water via the outer jacket of the autoclave. A fluidized seed particle of polymer (400 g) and 60 g of the pre-polymerized catalyst previously prepared above were introduced into the gas phase polymerization reactor under nitrogen atmosphere, provided with a stirring device rotating at 150 rpm and heated to 60° C. Nitrogen and hydrogen were charged into the reactor to provide total pressure of 3 bars and a given ratio of hydrogen and ethylene (P_{H2}/P_{C2}) partial pressure indicated in Table 2. After the reactor temperature was raised to 85° C., ethylene (5 bars) was charged into the reactor to obtain total pressure of 10 bars, together with 1-hexene (C₆) at a given C₆/C₂ molar ratio. The copolymerization was maintained at 85° C. The feed of C₆/C₂ was continued at a given C₆/C₂ molar ratio until 1000 g of ethylene was consumed during the gas phase polymerization. The reactor was then cooled down and degassed and an ethylene/1-hexene polymer free from agglomerate was drawn off. The polymer was collected for property tests. The results are reported in Table 2.

### Example 2

A prepolymerized catalyst was prepared in the same manner as in Example 1 except 25 mmoles of 1,1,3,3-tetramethyldisilazane (TMDS) were used instead of 25 mmols of 1,1,1,3,3,3-hexamethyldisilazane (HMDS) in Example 1. Small amount of the prepolymerized catalyst was taken to be deactivated with water and then washed with hexane prior to being used for property test, as showed in Table 1.

The copolymerization of ethylene and 1-hexene was conducted in the same manner as in Example 1 except prepolymerized catalyst in Example 2 was used instead of prepolymerized catalyst from Example 1. The polymer was collected for property tests. The results are reported in Table 2.

### Example 3

A prepolymerized catalyst was prepared in the same manner as in Example 1 except 50 mmoles of mMAO (modified MAO containing isobutylalumnoxane) were used instead of 90 mmols of MAO in Example 1. Small amount of the prepolymerized catalyst was taken to be deactivated with water and then washed with hexane prior to being used for property test, as showed in Table 1.

The copolymerization of ethylene and 1-hexene was conducted in the same manner as in Example 1 except prepolymerized catalyst in Example 3 was used instead of prepolymerized catalyst from Example 1. The polymer was collected for property tests. The results are reported in Table 2.

### Example 4

A prepolymerized catalyst was prepared in the same manner as in Example 2 except 50 mmoles of mMAO (modified MAO containing isobutylalumnoxane) were used instead of 90 mmols of mMAO in Example 2. Small amount of the prepolymerized catalyst was taken to be deactivated with water and then washed with hexane prior to being used for property test, as showed in Table 1.

The copolymerization of ethylene and 1-hexene was conducted in the same manner as in Example 1 except prepolymerized catalyst in Example 4 was used instead of prepolymerized catalyst from Example 1. The polymer was collected for property tests. The results are reported in Table 2.

### Example 5

A prepolymerized catalyst was prepared in the same manner as in Example 1 except 50 mmoles of DEAC was used instead of 50 mmoles of EADC in Example 1. Small amount of the prepolymerized catalyst was taken to be deactivated with water and then washed with hexane prior to being used for property test, as showed in Table 1.

The copolymerization of ethylene and 1-hexene was conducted in the same manner as in Example 1 except prepolymerized catalyst in Example 5 was used instead of prepolymerized catalyst from Example 1. The polymer was collected for property tests. The results are reported in Table 2.

### Example 6

A prepolymerized catalyst was prepared in the same manner as in Example 1 except 50 mmoles of EASC was used instead of 50 mmoles of EADC in Example 1. Small amount of the prepolymerized catalyst was taken to be deactivated with water and then washed with hexane prior to being used for property test, as showed in Table 1.

The copolymerization of ethylene and 1-hexene was conducted in the same manner as in Example 1 except prepolymerized catalyst in Example 6 was used instead of prepolymerized catalyst from Example 1. The polymer was collected for property tests. The results are reported in Table 2.

### Example 7

A prepolymerized catalyst was prepared in the same manner as in Example 1 except 50 mmoles of EADC was used instead of 50 mmoles of DMAC in Example 1. Small amount of the prepolymerized catalyst was taken to be deactivated with water and then washed with hexane prior to being used for property test, as showed in Table 1.

The copolymerization of ethylene and 1-hexene was conducted in the same manner as in Example 1 except prepolymerized catalyst in Example 7 was used instead of prepolymerized catalyst from Example 1. The polymer was collected for property tests. The results are reported in Table 2.

### Example 8

A prepolymerized catalyst was prepared in the same manner as in Example 1 except regular MAO was used instead of modified MAO (mMAO) in Example 1. Small amount of the prepolymerized catalyst was taken to be deactivated with water and then washed with hexane prior to being used for property test, as showed in Table 1.

The copolymerization of ethylene and 1-hexene was conducted in the same manner as in Example 1 except prepolymerized catalyst in Example 8 was used instead of prepolymerized catalyst from Example 1. The polymer was collected for property tests. The results are reported in Table 2.

### Comparative Example 1

A prepolymerized catalyst was prepared in the same manner as in Example 1 except EADC (50 mmols) was used as cocatalyst, without adding 90 mmoles of mMAO (modified MAO containing isobutylalumnoxane) in Example 1. Small amount of the prepolymerized catalyst was taken to be deactivated with water and then washed with hexane prior to being used for property test, as showed in Table 1.

The copolymerization of ethylene and 1-hexene was conducted in the same manner as in Example 1 except prepolymerized catalyst in Comparative Example 1 was used instead of prepolymerized catalyst from Example 1. The polymer was collected for property tests. The results are reported in Table 2.

### Comparative Example 2

A prepolymerized catalyst was prepared in the same manner as in Example 5 except DEAC (50 mmols) was used as cocatalyst, without adding 90 mmoles of mMAO (modified MAO containing isobutylalumnoxane) in Example 6. Small amount of the prepolymerized catalyst was taken to be deactivated with water and then washed with hexane prior to being used for property test, as showed in Table 1.

The copolymerization of ethylene and 1-hexene was conducted in the same manner as in Example 1 except prepolymerized catalyst in Comparative Example 2 was used instead of prepolymerized catalyst from Example 1. The polymer was collected for property tests. The results are reported in Table 2.

### Comparative Example 3

A prepolymerized catalyst was prepared in the same manner as in Example 6 except EASC (50 mmols) was used as cocatalyst, without adding 90 mmoles of mMAO (modified MAO containing isobutylalumnoxane) in Example 7. Small amount of the prepolymerized catalyst was taken to be deactivated with water and then washed with hexane prior to being used for property test, as showed in Table 1.

The copolymerization of ethylene and 1-hexene was conducted in the same manner as in Example 1 except prepolymerized catalyst in Comparative Example 3 was used instead of prepolymerized catalyst from Example 1. The polymer was collected for property tests. The results are reported in Table 2.

### Comparative Example 4

A prepolymerized catalyst was prepared in the same manner as in Example 7 except DMAC (50 mmols) was used as cocatalyst, without adding 90 mmoles of mMAO (modified MAO containing isobutylalumnoxane) in Example 8. Small amount of the prepolymerized catalyst was taken to be deactivated with water and then washed with hexane prior to being used for property test, as showed in Table 1.

The copolymerization of ethylene and 1-hexene was conducted in the same manner as in Example 1 except prepolymerized catalyst in Comparative Example 4 was used instead of prepolymerized catalyst from Example 1. The polymer was collected for property tests. The results are reported in Table 2.

### Comparative Example 5

A prepolymerized catalyst was prepared in the same manner as in Example 1 except TEA (50 mmols) was used without adding 50 mmols of EADC and 90 mmoles of mMAO (modified MAO containing isobutylalumnoxane) in Example 1. Small amount of the prepolymerized catalyst was taken to be deactivated with water and then washed with hexane prior to being used for property test, as showed in Table 1.

The copolymerization of ethylene and 1-hexene was conducted in the same manner as in Example 1 except prepolymerized catalyst in Comparative Example 5 was used instead of prepolymerized catalyst from Example 1. The polymer was collected for property tests. The results are reported in Table 2.

### Comparative Example 6

A prepolymerized catalyst was prepared in the same manner as in Example 1 except TnOA (50 mmols, tri-n-octyl aluminum) was used as cocatalyst, without adding 50 mmols of EADC and 90 mmoles of mMAO (modified MAO containing isobutylalumnoxane) in Example 1. Small amount of the prepolymerized catalyst was taken to be deactivated with water and then washed with hexane prior to being used for property test, as showed in Table 1.

The copolymerization of ethylene and 1-hexene was conducted in the same manner as in Example 1 except prepolymerized catalyst in Comparative Example 6 was used instead of prepolymerized catalyst from Example 1. The polymer was collected for property tests. The results are reported in Table 2.

### Comparative Example 7

A prepolymerized catalyst was prepared in the same manner as in Example 1 except 90 mmoles of mMAO (modified MAO containing isobutylalumnoxane) was used as cocatalyst, without adding EADC (50 mmols) in Example 1. Small amount of the prepolymerized catalyst was taken to be deactivated with water and then washed with hexane prior to being used for property test, as showed in Table 1.

The copolymerization of ethylene and 1-hexene was conducted in the same manner as in Example 1 except prepolymerized catalyst in Comparative Example 7 was used instead of prepolymerized catalyst from Example 1. The polymer was collected for property tests. The results are reported in Table 2.

### Comparative Example 8

A prepolymerized catalyst was prepared in the same manner as in Example 1 except TEA (50 mmols, triethylaluminum) was used instead of 90 mmoles of mMAO (modified MAO containing isobutylalumnoxane) in Example 1. Small amount of the prepolymerized catalyst was taken to be deactivated with water and then washed with hexane prior to being used for property test, as showed in Table 1.

The copolymerization of ethylene and 1-hexene was conducted in the same manner as in Example 1 except prepolymerized catalyst in Comparative Example 8 was used instead of prepolymerized catalyst from Example 1. The polymer was collected for property tests. The results are reported in Table 2.

### Comparative Example 9

A prepolymerized catalyst was prepared in the same manner as in Example 4 except TnOA (50 mmols, tri-n-octyl aluminum) was used instead of 90 mmoles of mMAO (modified MAO containing isobutylalumnoxane) in Example 4. Small amount of the prepolymerized catalyst was taken to be deactivated with water and then washed with hexane prior to being used for property test, as showed in Table 1.

The copolymerization of ethylene and 1-hexene was conducted in the same manner as in Example 1 except prepolymerized catalyst in Comparative Example 9 was used instead of prepolymerized catalyst from Example 1. The polymer was collected for property tests. The results are reported in Table 2.

### Comparative Example 10

A prepolymerized catalyst was prepared in the same manner as in Example 5 except TnOA (50 mmols, tri-n-octyl aluminum) was used instead of 90 mmoles of mMAO (modified MAO containing isobutylalumnoxane) in Example 5. Small amount of the prepolymerized catalyst was taken to be deactivated with water and then washed with hexane prior to being used for property test, as showed in Table 1.

The copolymerization of ethylene and 1-hexene was conducted in the same manner as in Example 1 except prepolymerized catalyst in Comparative Example 10 was used instead of prepolymerized catalyst from Example 1. The polymer was collected for property tests. The results are reported in Table 2.

### Comparative Example 11

A prepolymerized catalyst was prepared in the same manner as in Example 6 except TnOA (50 mmols) was used instead of 90 mmoles of mMAO (modified MAO containing isobutylalumnoxane) in Example 6. Small amount of the prepolymerized catalyst was taken to be deactivated with water and then washed with hexane prior to being used for property test, as showed in Table 1.

The copolymerization of ethylene and 1-hexene was conducted in the same manner as in Example 1 except prepolymerized catalyst in Comparative Example 11 was used instead of prepolymerized catalyst from Example 1. The polymer was collected for property tests. The results are reported in Table 2.

### Comparative Example 12

A prepolymerized catalyst was prepared in the same manner as in Example 7 except TnOA (50 mmols) was used instead of 90 mmoles of mMAO (modified MAO containing isobutylalumnoxane) in Example 7. Small amount of the prepolymerized catalyst was taken to be deactivated with water and then washed with hexane prior to being used for property test, as showed in Table 1.

The copolymerization of ethylene and 1-hexene was conducted in the same manner as in Example 1 except prepolymerized catalyst in Comparative Example 12 was used instead of prepolymerized catalyst from Example 1. The polymer was collected for property tests. The results are reported in Table 2.

### Comparative Example 13

A prepolymerized catalyst was prepared in the same manner as in Example 7 except TEA (50 mmols) was used instead of 130 mmoles of mMAO (modified MAO containing isobutylalumnoxane) in Example 7. Small amount of the prepolymerized catalyst was taken to be deactivated with water and then washed with hexane prior to being used for property test, as showed in Table 1.

The copolymerization of ethylene and 1-hexene was conducted in the same manner as in Example 1 except prepolymerized catalyst in Comparative Example 13 was used instead of prepolymerized catalyst from Example 1. The polymer was collected for property tests. The results are reported in Table 2.

### Comparative Example 14

A prepolymerized catalyst was prepared in the same manner as in Example 1 except without adding 25 mmols of 1,1,1,3,3,3-hexamethyldisilazane (HMDS) in Example 1. Small amount of the prepolymerized catalyst was taken to be deactivated with water and then washed with hexane prior to being used for property test, as showed in Table 1.

The copolymerization of ethylene and 1-hexene was conducted in the same manner as in Example 1 except prepolymerized catalyst in Comparative Example 14 was used instead of prepolymerized catalyst from Example 1. The polymer was collected for property tests. The results are reported in Table 2.

### Comparative Example 15

A prepolymerized catalyst was prepared in the same manner as in Comparative Example 8 except without adding 25 mmols of 1,1,1,3,3,3-hexamethyldisilazane (HMDS) in Comparative Example 8. Small amount of the prepolymerized catalyst was taken to be deactivated with water and then washed with hexane prior to being used for property test, as showed in Table 1.

The copolymerization of ethylene and 1-hexene was conducted in the same manner as in Example 1 except prepolymerized catalyst in Comparative Example 15 was used instead of prepolymerized catalyst from Example 1. The polymer was collected for property tests. The results are reported in Table 2.

### Comparative Example 16

A prepolymerized catalyst was prepared in the same manner as in Comparative Example 11 except without adding 25 mmols of 1,1,1,3,3,3-hexamethyldisilazane (HMDS) in Comparative Example 11. Small amount of the prepolymerized catalyst was taken to be deactivated with water and then washed with hexane prior to being used for property test, as showed in Table 1.

The copolymerization of ethylene and 1-hexene was conducted in the same manner as in Example 1 except prepolymerized catalyst in Comparative Example 16 was used instead of prepolymerized catalyst from Example 1. The polymer was collected for property tests. The results are reported in Table 2.

TABLE 1

| | | | | Prepolymerized Catalyst | | | | |
|---|---|---|---|---|---|---|---|---|
| | Prepolymerization | | | Average | | | | |
| | | Molar | Polymer | particle | | | | |
| | | Ratio of | Yield, | size | Fine (80 | | JC-α | |
| | | Cocatalyst, | gPE/ | (APS), | micron) | | (LCB/ | |
| Sample | Cocatalyst | mol/mol | mmolTi | micron | wt % | SPAN | 10⁶ C) | Flowability |
| Example 1 | mMAO/DMAC | 1.8 | 41 | 225 | 9.5 | 1.2 | 3.2 | +2 |
| Example 2 | mMAO/DMAC | 1.8 | 42 | 238 | 9.0 | 1.3 | 2.8 | +2 |
| Example 3 | mMAO/DMAC | 1.0 | 45 | 245 | 8.0 | 1.3 | 3.2 | +2 |
| Example 4 | mMAO/DMAC | 1.0 | 42 | 235 | 7.5 | 1.3 | 3.1 | +2 |
| Example 5 | mMAO/DEAC | 1.0 | 40 | 226 | 8.5 | 1.3 | 3.0 | +3 |
| Example 6 | mMAO/EASC | 1.0 | 43 | 235 | 7.5 | 1.2 | 3.3 | +1 |
| Example 7 | mMAO/EADC | 1.0 | 45 | 245 | 6.5 | 1.2 | 3.5 | +3 |
| Example 8 | MAO/EDAC | 1.0 | 42 | 235 | 9.0 | 1.2 | 3.1 | +2 |
| Comparative | EADC | | 45 | 238 | 11.8 | 1.6 | 0 | −1 |
| Example 1 | | | | | | | | |
| Comparative | DEAC | | 43 | 248 | 11.9 | 1.5 | 0 | −1 |
| Example 2 | | | | | | | | |
| Comparative | ESAC | | 41 | 252 | 11.4 | 1.6 | 0 | −1 |
| Example 3 | | | | | | | | |
| Comparative | DMAC | | 46 | 255 | 11.7 | 1.4 | 0 | −1 |
| Example 4 | | | | | | | | |
| Comparative | TEA | | 44 | 223 | 12.8 | 1.5 | 0 | −1 |
| Example 5 | | | | | | | | |
| Comparative | TnOA | | 43 | 235 | 10.4 | 1.5 | 0 | 0 |
| Example 6 | | | | | | | | |
| Comparative | mMAO | | 40 | 220 | 10.3 | 1.2 | 0 | 0 |
| Example 7 | | | | | | | | |
| Comparative | TEA/EADC | 1.0 | 42 | 238 | 11.8 | 1.7 | detectable | −1 |
| Example 8 | | | | | | | | |
| Comparative | TnOA/EADC | 1.0 | 40 | 225 | 11.2 | 1.6 | n.d | −1 |
| Example 9 | | | | | | | | |
| Comparative | TnOA/DEAC | 1.0 | 41 | 235 | 11.5 | 1.5 | n.d | −1 |
| Example 10 | | | | | | | | |
| Comparative | TnOA/DMAC | 1.0 | 42 | 225 | 11.5 | 1.6 | n.d | −1 |
| Example 11 | | | | | | | | |
| Comparative | TnOA/ESAC | 1.0 | 42 | 230 | 12.5 | 1.5 | n.d | −1 |
| Example 12 | | | | | | | | |
| Comparative | TEA/DMAC | 1.0 | 43 | 225 | 13.5 | 1.6 | n.d | −1 |
| Example 13 | | | | | | | | |
| Comparative | mMAO/EADC* | 1.8 | 43 | 215 | 11.5 | 1.6 | 3.2 | −3 |
| Example 14 | | | | | | | | |
| Comparative | TEA/EADC* | 1.2 | 42 | 225 | 11.8 | 1.6 | detectable | −3 |
| Example 15 | | | | | | | | |
| Comparative | TnOA/DMAC* | 1.2 | 43 | 228 | 11.2 | 1.6 | n.d | −3 |
| Example 16 | | | | | | | | |

Note:
*indicating that prepolymerized catalyst was prepared without disilazane modifier.

TABLE 2

| | H2/C2 | C6/C2 | Catalyst | Bulk | | | | |
|---|---|---|---|---|---|---|---|---|
| Example | ratio | ratio | activity | density | Density | MI | MFR | JC-α |
| 1 | 0.21 | 0.0785 | 1585 | 0.36 | 0.9138 | 0.75 | 36.4 | 2.6 |
| 2 | 0.21 | 0.0785 | 1465 | 0.37 | 0.9150 | 0.71 | 36.8 | 2.8 |
| 3 | 0.21 | 0.0908 | 1405 | 0.38 | 0.9100 | 0.73 | 35.9 | 2.9 |
| 4 | 0.24 | 0.0785 | 1392 | 0.37 | 0.9155 | 0.74 | 36.7 | 2.7 |
| 5 | 0.26 | 0.0785 | 1546 | 0.36 | 0.9161 | 0.69 | 36.6 | 2.3 |
| 6 | 0.27 | 0.0785 | 1593 | 0.35 | 0.9156 | 0.64 | 35.8 | 3.0 |
| 7 | 0.29 | 0.0785 | 1408 | 0.36 | 0.9153 | 0.90 | 40.2 | 3.5 |
| 8 | 0.28 | 0.0785 | 1308 | 0.37 | 0.9153 | 0.89 | 35.3 | 2.5 |
| Comparative | 0.29 | 0.0808 | 343 | 0.34 | 0.9180 | 0.81 | 29.3 | 0 |
| Exam 1 | | | | | | | | |
| Comparative | 0.31 | 0.0808 | 320 | 0.34 | 0.9168 | 0.88 | 27.1 | 0 |
| Exam 2 | | | | | | | | |
| Comparative | 0.32 | 0.0808 | 290 | 0.33 | 0.9172 | 0.89 | 28.0 | 0 |
| Exam 3 | | | | | | | | |
| Comparative | 0.30 | 0.0898 | 612 | 0.35 | 0.9178 | 0.87 | 28.4 | 0 |
| Exam 4 | | | | | | | | |
| Comparative | 0.31 | 0.0898 | 657 | 0.34 | 0.9154 | 0.73 | 32.5 | 0 |
| Exam 5 | | | | | | | | |
| Comparative | 0.31 | 0.0898 | 1516 | 0.36 | 0.9168 | 0.70 | 27.1 | 0 |
| Exam 6 | | | | | | | | |
| Comparative | 0.31 | 0.0988 | 1022 | 0.35 | 0.9195 | 1.56 | 27.4 | n.d |
| Exam 7 | | | | | | | | |
| Comparative | 0.29 | 0.0808 | 1043 | 0.35 | 0.9170 | 0.81 | 31.3 | n.d |
| Exam 8 | | | | | | | | |
| Comparative | 0.32 | 0.0808 | 909 | 0.35 | 0.9162 | 1.05 | 32.3 | n.d |
| Exam 9 | | | | | | | | |
| Comparative | 0.29 | 0.0898 | 771 | 0.35 | 0.9175 | 0.94 | 30.4 | n.d |
| Exam 10 | | | | | | | | |
| Comparative | 0.29 | 0.0898 | 904 | 0.34 | 0.9170 | 0.91 | 31.0 | n.d |
| Exam 11 | | | | | | | | |
| Comparative | 0.31 | 0.0988 | 918 | 0.35 | 0.9175 | 0.90 | 31.8 | n.d |
| Exam 12 | | | | | | | | |
| Comparative | 0.29 | 0.0785 | 610 | 0.35 | 0.9178 | 0.68 | 32.4 | n.d |
| Exam 13 | | | | | | | | |
| Comparative | 0.32 | 0.0785 | 1130* | 0.34 | 0.9154 | 0.89 | 36.5 | 2.8 |
| Exam 14 | | | | | | | | |
| Comparative | 0.29 | 0.0808 | 1043* | 0.36 | 0.9170 | 0.81 | 33.1 | n.d |
| Exam 15 | | | | | | | | |
| Comparative | 0.33 | 0.0898 | 913* | 0.35 | 0.9175 | 0.90 | 31.8 | n.d |
| Exam 16 | | | | | | | | |

Note:
*indicating chunk formation or poor operability due to reactor fouling in gas phase polymerization.

Table 1 summarizes the composition of prepolymerized catalysts, and the properties of prepolymerized catalyst including rheological study based on the Janzen-Colby model. The yield of ethylene polymer in the prepolymerized catalyst falls into the typical range of 40-50 g PE/mmol Ti. The inventive prepolymerized catalysts, prepared by using said catalyst precursor, olefin, and said activator in-situ formed by contacting the mixture of cocatalysts alkylalumoxane (B)/alkylaluminum dihalide (C) with R₃Si—NH—SiR₃-type disilazanes (component D), show sporadic long chain branches (JC-α≈3 LCBs per million carbons), while no significant LCBs are detected in the comparative prepolymerized catalysts prepared with the mixing cocatalyst of alkylalumimum/alkylaluminum dihalide. Different from Assignee's prior patents such as U.S. Pat. Nos. 10,344,105 and 11,952,445, the prepolymerized catalyst of the present invention has better morphology, less fine particle size, and less static/better powder flow ability. It was found that reactor operability is deteriorated due to reactor fouling when alkylaluminum dihalide is contacted with catalyst precursor or prepolymer. The addition of R₃Si—NH—SiR₃-type disilazanes in preparing prepolymerized catalyst in this invention will benefit for the improvement of operability in the olefin polymerization, in particular, gas phase polymerization.

According to the method of the present invention, a prepolymerized catalyst which is capable of preventing fouling of olefin polymer particles to a polymerization reactor is obtained, and if an olefin is polymerized using this prepolymerized catalyst, without adding additional cocatalyst during olefin polymerization, fouling of olefin polymer particles to a polymerization reactor can be prevented when producing polymer with very low density of less than 0.9130, as demonstrated in Table 2.

From Table 2 one can see that the prepolymerized catalysts of the present invention, prepared by using said catalyst precursor, olefin, and said activator in-situ formed by contacting the mixture of cocatalysts alkylalumoxane (B)/alkylaluminum dihalide (C) with R₃Si—NH—SiR₃-type disilazanes (component D) show high activity and better operability in gas phase polymerization (without reactor fouling). The inventive prepolymerized catalyst produce polyethylene (co) polymers having sporadic long chain branches (JC-α≈3 LCBs per million carbons) in high molecular weight fractions, comprising a high molecular weight tail, along with reversed comonomer composition distribution. As a result, polyethylene (co) polymers produced with the inventive prepolymerized catalyst shows improved processability, enhanced melt strength, and improved optical properties, as demonstrated in Table 3. The inventive resin produced by the said inventive prepolymerized catalyst has a superior balance of physical properties and optical properties. Compared to the resin from TnOA (comparative example 6), the inventive resin (Example 1) shows improved optical properties (low haze, high clarity and high gloss), which are in par with those of C8-LLDPE and mLLDPE polymers, while it still demonstrates excellent tear strength, toughness (e.g. dart impact), and stiffness (secant modulus at 1% strain). Polyethylene resins produced with inventive prepolymerized catalyst integrate the advantageous properties of both ZN LLDPE type resin and mLLDPE resin.

TABLE 3

| | | Comparative | | |
|---|---|---|---|---|
| | Example 7 | Example 6 | C8 LLDPE | mLLDPE |
| Cocatalyst | mMAO/ | TnOA | — | — |
| | EADC | | | |
| Pellet MI | 0.75 | 0.75 | 0.99 | 0.96 |
| Pellet Density | 0.9195 | 0.9195 | 0.9214 | 0.9213 |
| M_{z}/M_{w} | 3.2 | 2.9 | 3.2 | 1.9 |
| Tₘ (° C.) | 124.1 | 124.7 | 123.4 | 118.7 |
| Haze | 9.9 | 21.0 | 10.1 | 10.2 |
| Clarity | 92 | 86 | 92 | 93 |
| Gloss (45°) | 80 | 50 | 75 | 73 |
| MSI | 0.33 | 0.10 | 0.08 | 0.04 |
| Dart impact | 496 | 495 | 270 | 468 |
| MD tear | 475 | 458 | 351 | 254 |
| TD tear | 561 | 614 | 548 | 347 |
| MD sec. | 17288 | 16909 | 17442 | 17676 |
| mod @1% | | | | |
| strain | | | | |
| TD sec. | 19625 | 17825 | 16842 | 17910 |
| mod @1% | | | | |
| strain | | | | |
| Melt | 4513 | 5290 | 4497 | 6090 |
| pressure | | | | |
| (psi) | | | | |

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings therein. It is therefore evident that the particular embodiments disclosed above may be altered or modified and all such variations are considered within the scope and sprit of the present invention.

What is claimed is:

1. A method of preparing a prepolymerized catalyst for producing an olefin polymer, comprising reacting:
a. a magnesium-based supported catalyst precursor (component A) comprising a halide of a transition metal in any of group 4 to 8 of the periodic table of elements and a nitrogen-based electron donor;
b. an activator produced in-situ by contacting alkylaluminoxane (component B) with halogenated alkylaluminum compound (component C) and a R3Si—NH—SiR3-type disilazane (component D);
c. ethylene; and
d. hydrogen.

2. The method of claim 1, further comprising reacting (1)-(iv) with one or more alpha-olefins.

3. The method of claim 1, wherein the particle size of the fine particles of the prepolymerized catalyst can be no larger than D¹ represented by the following formula:
$${D}^{1} = ( average particle size of prepolymerized catalyst particles ) \times 0.35$$

4. The method of claim 1, wherein the particle size distribution span ((d₉₀−d₁₀)/d₅₀) of the prepolymerized catalyst is below about 1.5.

5. The method of claim 1, wherein the particle size distribution span ((d₉₀−d₁₀)/d₅₀) of the prepolymerized catalyst is below about 1.2.

6. The method of claim 1, wherein the amount of fine particles (<80 micron) in the prepolymerized catalyst is in the range of from about 2 wt. % to about 11 wt. %.

7. The method of claim 1, wherein the amount of fine particles (<80 micron) in the prepolymerized catalyst is in the range of from about 5 wt. % to about 10 wt. %.

8. The method of claim 1, wherein the prepolymerized catalyst contains from about 10 g to about 500 g polyolefin per g of catalyst precursor (component A).

9. The method of claim 1, wherein the catalyst precursor (component A) is prepared by contacting:
i) a magnesium-based support with a halide solution comprising RX, wherein R is C1-C20 hydrocarbyl or aryl, and X is halogen;
ii) component (b1) formed by reacting compound contacting halogen-substituted silane represented by R¹ₓSiX_{y} with alkoxysilane ester represented by R²ₘSi(OR³)ₙ, wherein R¹, R², and R³ are independently selected from C1-C20 hydrocarbyl, X is halogen, x is an integer from 1 to 3, y is an integer from 1 to 4, x+y=4, m is an integer from 0 to 3, n Is an integer from 1 to 4, and m+n=4;
iii) a compound (b2) having the formula MX₄, wherein M is an early transition metal and wherein X is a halogen; and
iv) a compound (b3) having the formula M(OR⁴)₄, wherein M is an early transition metal and wherein R⁴ is a C₁-C₂₀ hydrocarbyl compound comprising a nitrogen aromatic compound; and
v) a compound (b4) having the formula R⁵X, wherein R⁵ is C1-C20 hydrocarbyl or aryl, and wherein X is halogen.

10. The method of claim 9, wherein M is titanium.

11. The method claim 1, wherein component B is selected from methylalumoxane, modified methylalumoxane, tetraethyldialumoxane, tetrabutylalumoxane, bis(diisobutylaluminum) oxide, ethylalumoxane, isobutylalumnoxane, polymethylalumoxane, or combinations thereof.

12. The method of claim 1, wherein component C is selected from dimethylaluminum chloride, diethylaluminum halides, such as dimethylaluminum chloride, diethylaluminum chloride, diisobutylaluminum chloride, di(t-butyl)aluminum chloride, and diamylaluminum chloride; alkylaluminum dihalides, such as methylaluminum dichloride, ethylaluminum dichloride, isobutylaluminum dichloride, isobutylaluminum dichloride, t-butylaluminum dichloride; amylaluminum dichloride; or combinations thereof.

13. The method of claim 1, wherein component D has the formula R⁸₃Si—NH—SiR⁹₃, wherein R⁸ and R⁹ are independently selected from hydrogen or any C₁-C₂₀ hydrocarbyl and aryl.

14. The method of claim 1, wherein component D is selected from 1,1,1,3,3,3-hexamethyldisilazane (HMDS) and 1,1,3,3-tetramethyldisilazane (TMDS), 1,3-divinyl-1,1,3,3-tetramethyldisilazane, various 1,3-dichlorodisilazanes, 1,1,1-trimethyl-3,3,3-triphenyldisilazane, 1,1,3,3-tetramethyl-1,3-divinyldisilazane, 1,1,3,3-tetramethyl-1,3-diphenyldisilazane, or 1,3-dimethyl-1,1,3,3-diphenyldisilazane.

15. The method of claim 1, wherein the molar ratio of component B and component D is in the range from about 0.1 to about 100.
